(19) United States
(12) Patent Application Publication
(10) Pub. No.: US 2016/0216828 A1
(43) Pub. Date: Jul. 28, 2016

(54) IMAGE DISPLAY TERMINAL AND METHOD OF CONTROLLING A TOUCH THEREOF

(71) Applicant: Samsung Display Co., Ltd., Yongin-si (KR)

(72) Inventor: Hoeung Lee, Suwon-si (KR)

(21) Appl. No.: 14/850,484

(22) Filed: Sep. 10, 2015

(30) Foreign Application Priority Data
Jan. 26, 2015 (KR) 10-2015-0012307

(51) Int. Cl. G06F 3/041; G06F 3/0488; G06F 3/044

(52) U.S. Cl. CPC G06F 3/0416; G06F 3/044; G06F 3/0412; G06F 3/0488

(57) ABSTRACT

An image display terminal and a method of controlling a touch for an image display terminal are disclosed. In one aspect, the method includes displaying a first widget in a first area on a touch screen and a second widget in a second area on the touch screen different from the first area. The method also includes extracting a first touch policy of the first widget and a second touch policy of the second widget. The method further includes individually controlling touch driving characteristics of the first and second areas based on the first and second touch policies.

### INCORPORATION BY REFERENCE TO ANY PRIORITY APPLICATIONS

This U.S. non-provisional patent application claims priority under 35 U.S.C. §119 of Korean Patent Application No. 10-2015-0012307, filed on Jan. 26, 2015, the entire contents of which are hereby incorporated by reference.

### BACKGROUND

1. Field

The described technology generally relates to an image display terminal and a method of controlling a touch thereof.

2. Description of the Related Technology

The use of terminals such as smartphones, PDAs, and tablet computers is expanding. These devices include a touch screen panel, which a user can control using a graphic user interface (GUI) via touch.

### SUMMARY OF CERTAIN INVENTIVE ASPECTS

One inventive aspect relates to an image display terminal of which touch sensitivity or a touch reaction speed of a touch screen panel is increased and power consumption is improved, and a touch control method thereof.

Another aspect is a touch control method of an image display terminal. The touch control method includes: displaying a first widget in a first area on a screen displayed on a touch screen and a second widget in a second area different from the first area on the screen; extracting a touch using policy of the first widget and a touch using policy of the second widget; and individually controlling touch driving characteristics of the first and second areas on a basis of the touch using policies of the first and second widgets.

In some embodiments, the individually controlling of the touch driving characteristics includes performing a control so that the first and second areas have different touch sensitivities.

In some embodiments, the individually controlling of the touch driving characteristics includes performing a control so that the first and second areas have different touch reaction speeds.

In some embodiments, the individually controlling of the touch driving characteristics includes performing a control so that a first ratio of scan-driven touch lines among touch lines disposed in the first area in a first direction and a second ratio of scan-driven touch lines among touch lines disposed in the second area in the first direction are different.

In some embodiments, the individually controlling of the touch driving characteristics includes activating touch sensitivity of the first area and deactivating touch sensitivity of the second area.

In some embodiments, the touch control method further includes determining whether content of the screen is changed; and in a case where the content of the screen is changed, proceeding to an operation of displaying the first widget in the first area on the screen and displaying the second widget in the second area different from the first area on the screen.

In some embodiments, the determining of whether content of the screen is changed includes: determining whether at least any one of the first and second areas is changed; and determining whether at least any one of the first and second widgets is changed.

In some embodiments, the determining of whether the content of the screen is changed includes determining that the content of the screen is changed when at least one of the first and second areas is changed or at least one of the first and second widgets is changed.

Another aspect is an image display terminal that includes a touch screen panel, a touch driving unit, a window manager, and a touch manager.

In some embodiments, a touch screen panel displays a first widget in a first area and a second widget in a second area different from the first area, and sense an input touch event.

In some embodiments, a touch driving unit controls touch sensing of the touch screen panel and create a coordinate of the touch event.

In some embodiments, a window manager manages a touch using policy of the first widget and a touch using policy of the second widget.

In some embodiments, a touch manager extracts the touch using policies of the first and second widgets from the window manager to provide the extracted touch using policies to the touch driving unit.

In some embodiments, the touch driving unit individually controls touch driving characteristics of the first and second areas on a basis of the touch using policies of the first and second widgets.

In some embodiments, the touch driving unit performs a control so the first and second areas have different touch sensitivities.

In some embodiments, the touch driving unit performs a control so that the first and second areas have different touch speeds.

In some embodiments, the touch screen panel includes a plurality of touch lines disposed in a first direction, and the touch driving unit performs a control so that a first ratio of scan-driven touch lines among touch lines disposed in the first area and a second ratio of scan-driven touch lines among the touch lines disposed in the second area are different.

In some embodiments, the touch driving unit activates touch sensitivity of the first area and deactivates touch sensitivity of the second area.

In some embodiments, the touch screen panel includes a display unit displaying the image and a touch unit sensing the touch event.

Another aspect is a method of controlling a touch for an image display terminal, the method comprising: displaying a first widget in a first area on a touch screen and a second widget in a second area on the touch screen different from the first area; extracting a first touch policy of the first widget and a second touch policy of the second widget; and individually controlling touch driving characteristics of the first and second areas based on the first and second touch policies.

In the above method, the individually controlling of the touch driving characteristics comprises controlling the first and second areas to have different touch sensitivities.

In the above method, the individually controlling of the touch driving characteristics comprises controlling the first and second areas to have different touch reaction speeds.

In the above method, the first area includes a plurality of first touch lines formed in a first direction, wherein the second area includes a plurality of second touch lines formed in the first direction, wherein the individually controlling of the touch driving characteristics comprises controlling a first ratio of scan-driven touch lines to the first touch lines and a second ratio of scan-driven touch lines to the second touch lines to be different.

In the above method, the individually controlling of the touch driving characteristics comprises activating touch sensitivity of the first area and deactivating touch sensitivity of the second area.

The above method further comprises: determining whether content of the screen has changed; and displaying the first widget in the first area and the second widget in the second area when the content of the screen has changed.

In the above method, the determining of whether the content of the screen has changed comprises: determining whether at least any one of the first and second areas has changed; and determining whether at least any one of the first and second widgets has changed.

In the above method, the determining of whether the content of the screen has changed further comprises determining that the content of the screen has changed when at least one of the first and second areas has changed or at least one of the first and second widgets has changed.

Another aspect is an image display terminal, comprising: a touch screen panel configured to i) display a first widget in a first area and a second widget in a second area different from the first area and ii) sense an input touch event; a touch driver configured to control a touch sensing of the touch screen panel and create a coordinate of the touch event; a window manager configured to manage a first touch policy of the first widget and a second touch policy of the second widget; and a touch manager configured to extract the first and second touch policies from the window manager to provide the extracted first and second touch policies to the touch driver, wherein the touch driver is further configured to individually control touch driving characteristics of the first and second areas based on the first and second touch policies.

In the above image display terminal, the touch driver is further configured to control the first and second areas to have different touch sensitivities.

In the above image display terminal, the touch driver is further configured to control the first and second areas to have different touch speeds.

In the above image display terminal, the touch screen panel comprises a plurality of touch lines formed in a first direction, wherein the touch lines include first and second touch lines formed in the first and second areas, wherein the first and second touch lines each include one or more scan-driven touch lines and wherein the touch driver is further configured to control a first ratio of the one or more scan-driven touch lines to the first touch lines and a second ratio of one or more scan-driven touch lines to the touch lines are different.

In the above image display terminal, the touch driver is further configured to activate touch sensitivity of the first area and deactivate touch sensitivity of the second area.

In the above image display terminal, the touch screen panel comprises: a display configured to display an image including the first and second widgets; and a touch sensor configured to sense the input touch event.

Another aspect is an image display terminal, comprising: a touch screen panel configured to i) display a first widget in a first area and a second widget in a second area different from the first area and ii) sense an input touch event, wherein the first and second widgets respectively have first and second touch policies; a touch driver configured to control a touch sensing of the touch screen panel and create a coordinate of the touch event; and a touch manager configured to provide the first and second touch policies to the touch driver, wherein the touch driver is further configured to individually control touch driving characteristics of the first and second areas based on the first and second touch policies.

The above image display terminal further comprises an application processor configured to control the touch screen panel and the touch driver.

In the above image display terminal, the touch driver is further configured to control the first and second areas to have different touch sensitivities.

In the above image display terminal, the touch driver is further configured to control the first and second areas to have different touch speeds.

In the above image display terminal, the touch screen panel comprises a plurality of touch lines formed in a first direction, wherein the touch lines include first and second touch lines formed in the first and second areas, wherein the first and second touch lines each include one or more scan-driven touch lines, and wherein the touch driver is further configured to control a first ratio of the one or more scan-driven touch lines to the first touch lines and a second ratio of one or more scan-driven touch lines to the touch lines are different.

In the above image display terminal, the touch driver is further configured to activate touch sensitivity of the first area and deactivate touch sensitivity of the second area.

### BRIEF DESCRIPTION OF THE DRAWINGS

FIG. 1 is a block diagram illustrating an image display terminal according to an embodiment.

FIG. 2 illustrates an exemplary touch unit of FIG. 1.

FIG. 3 illustrates a touch screen panel on which an application of FIG. 1 is displayed.

FIG. 4 is a flowchart illustrating a touch control method of an image display terminal according to an embodiment.

FIG. 5 is a flowchart illustrating an operation of FIG. 4.

### DETAILED DESCRIPTION OF CERTAIN INVENTIVE EMBODIMENTS

In devices with touch screen panels, a plurality of applications can be executed and displayed in different areas on the same screen. However, a touch screen panel typically applies one identical touch driving policy for one screen. Accordingly, a touch detecting function of the touch screen panel may not be efficiently used and power consumption can be increased by an increase in unnecessary touch driving area.

The described technology can be variously modified and realized in various forms, and thus specific embodiments will be exemplified in the drawings and described in detail hereinbelow. However, the described technology is not limited to the specific disclosed forms, and needs to be construed to include all modifications, equivalents, or replacements included in the spirit and technical range of the described technology.

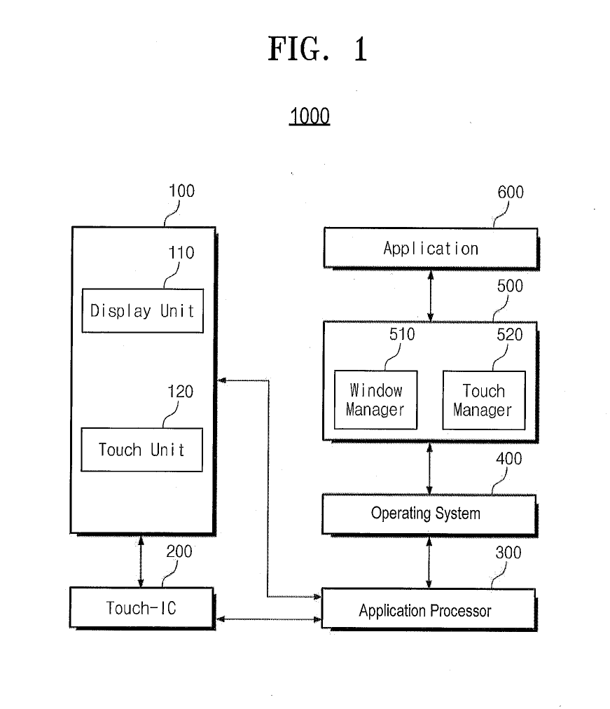

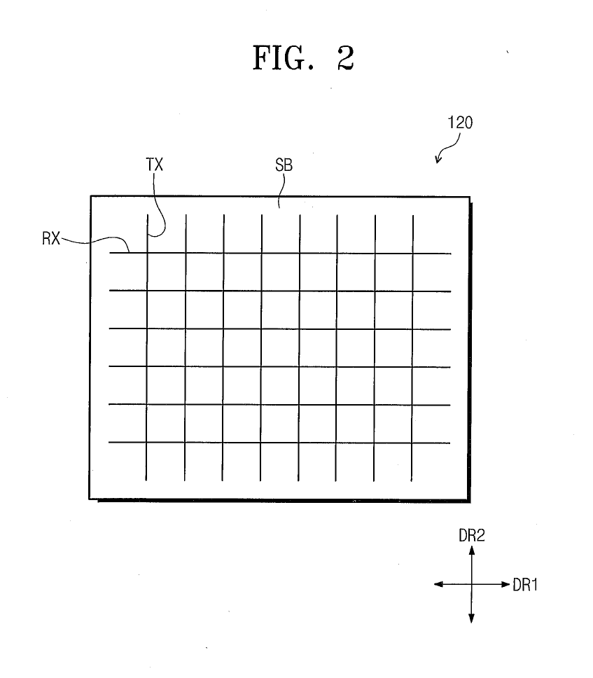

FIG. 1 is a block diagram illustrating an image display terminal according to an embodiment. Depending on embodiments, certain elements may be removed from or additional elements may be added to the image display terminal 1000 illustrated in FIG. 1. Furthermore, two or more elements may be combined into a single element, or a single element may be realized as multiple elements. This also applies to the remaining disclosed embodiments. FIG. 2 illustrates an exemplary touch unit of FIG. 1.

An image display terminal 1000 can be configured with an information communication device such as a mobile communication terminal, handheld computer, tablet computer, multimedia player (PMP), personal digital assistant (PDA), smartphone, and MP3 player, or a multimedia device.

The image display terminal 1000 can be implemented with hardware and software.

The image display terminal 1000 can include a touch screen panel 100, a touch driving unit (touch-IC) (or touch driver) 200, and an application processor (AP) 300.

The touch screen panel 100 can include a display unit (or display) 110 displaying an image, and a touch unit (or touch sensor) 120 recognizing an input touch. The touch screen panel 100 can be flexible.

The display unit 110 can be formed with a liquid crystal display (LCD), an organic light-emitting diode (OLED) display, a plasma display panel, an electrophoretic display, or an electrowetting display, and visually provide a user with options for using the image display terminal 1000, input data, function setting information, and other various pieces of information.

The touch unit 120 recognizes a touch event by a user. The touch unit 120 can be formed with a touch sensing sensor of a capacitive overlay type, a resistive overly type, or an infrared beam type.

An exemplary structure of the touch unit 120 of the capacitive type will be described with reference to FIG. 2. The touch unit 120 can include first touch lines RX and second touch lines TX formed on a substrate SB. The substrate SB can be a substrate formed on or included in the display unit 110.

The first touch lines RX can extend in a first direction DR1. The first touch lines RX can be prepared in plurality, and separated from each other in a second direction DR2 crossing the first direction DR1.

The second touch lines TX can extend in the second direction DR2. The second touch lines TX can be prepared in plurality, and separated from each other in the first direction DR1. The first touch lines RX and the second touch lines TX can be insulated from each other.

The touch unit 120 can recognize a touch input on the basis of a capacitance change amount of a capacitor formed by the first and second touch lines RX and TX.

The touch-IC 200 can control a touch sensing related operation of the touch screen panel 100. The touch-IC 200 can drive the touch unit 120, and create, a coordinate of a touch event occurring in the touch unit 120.

The touch-IC 200 can perform a scan-drive on the first and second touch lines RX and TX. The touch-IC 200 can provide first touch signals to the first touch lines RX and calculate delay values of the first touch signals to recognize a coordinate in the second direction DR2 of the occurred touch event. In addition, the touch-IC 200 can provide second touch signals to the second touch lines TX and calculate delay values of the second touch signals to recognize a coordinate in the first direction DR1 of the occurred touch event.

The touch-IC 200 can be directly mounted in the touch screen panel 100 in an integrated chip form, mounted on a flexible printed circuit board to be attached to the touch screen panel 100 in a form of a tape carrier package (TCP), or mounted on a separate printed circuit board.

The AP 300 can control an overall operation of the image display terminal 1000. The AP 300 can receive the coordinate of the touch event from the touch-IC 200 and provide a touch using policy of the application 600 in execution to the touch-IC 200.

Software can include an operating system (OS) 400, middleware 500, and an application 600. The software can be stored in a memory (not illustrated) of the image display terminal 1000.

The OS 400 plays a role of an interface between the application 600 and the AP 300 or between the middleware 500 and the AP 300. For example, the AP 300 receives the touch using policy of the application 600 in execution from the middleware 500 through the OS 400.

The middleware 500 is software playing a role of relay between the application 600 and the OS 400. The application 600 and the operation system 400 can exchange data through the middleware 500. However, the embodiment is not limited thereto and the function of the middleware 500 can be implemented in hardware.

The middleware 500 can include a window manager 510 and a touch manager.

The window manager 510 receives requests for an output screen from the application 600 and creates one image to be displayed on the touch screen panel 100 by combining the received requests for the output screen.

The window manager 510 can have input data for executing a specific task in the application 600 in execution displayed on the touch screen panel 100, and information on a task to be executed according to the input data. For example, the input data from which an event will occur is a specific touch coordinate where a touch event occurs. The window manager 510 can have information on the touch using policy of the application 600 in execution displayed on the touch screen panel 100.

The touch manager 520 can extract the touch using policy of the application 600 in execution displayed on the touch screen panel 100 from the window manager 510. The touch manager 520 can provide the extracted touch using policy to the touch-IC 200 through the OS 400 and the AP 300.

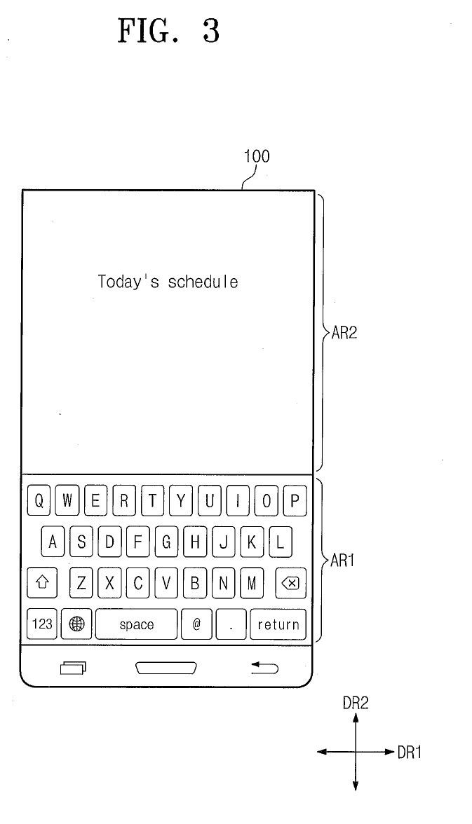

FIG. 3 illustrates a touch screen panel on which an application in execution of FIG. 1 is displayed.

FIGS. 1 and 3 exemplarily illustrate where the application in execution in an image display terminal is a memo application.

When the memo application is executed, a first widget can be displayed in a first area AR1 of the touch screen panel 100 and a second widget can be displayed in a second area AR2 of the touch screen panel 100. For example, the first widget is a keypad that is input by a touch and the second widget is an output result that is input from the first widget.

The first and second widgets can have different touch using policies. As an example, for the first widget, touch sensitivity that can sense a finger of the user is sufficient, but a rapid reaction speed according to a touch can be necessary. As an example, even though a touch event occurs, the second widget has no task to be executed and accordingly, reception of a touch coordinate is not necessary.

The window manager 510 can manage touch using policies of the first and second widgets. The touch manager 520 can extract the touch using policies of the first and second widgets from the window manager 510, and provide the extracted touch using policies of the first and second widgets to the touch-IC 200 through the OS 400 and the AP 300.

The touch-IC 200 can individually control touch driving characteristics of the first area AR1 and the second area AR2 on the basis of the touch using policies of the first and second widgets.

The touch-IC 200 can control the touch unit 120 so that the first and second areas AR1 and AR2 have different touch sensitivities. The touch-IC 200 can perform a control so that the first and second areas AR1 and AR2 have different touch reaction speeds. The touch-IC 200 can deactivate the touch sensitivity of the first area AR1 and activate the touch sensitivity of the second area AR2.

For example, the touch-IC 200 controls the touch unit 120 so that the touch sensitivity of the first AR1 is relatively low and the reaction speed thereof is relatively high according to the touch using policy of the first widget. In addition, the touch-IC 200 can deactivate the touch sensing of the second area AR2 according to the touch using policy of the second widget and not recognize any touch event occurring in the second area AR2.

The touch-IC 200 can control the touch sensitivity and touch reaction speed by adjusting the numbers of the first and second touch lines to scan-drive among the first touch lines RX and the second touch lines TX respectively formed in the first area AR1 and the second area AR2. As the numbers of the first and second scan drive touch lines are greater, the touch sensitivity can be improved and the touch reaction speed can be reduced.

Referring to FIGS. 2 and 3, the first touch lines RX extending in the first direction DR1 are formed in the first and second areas AR1 and AR2. The touch-IC 200 can perform a control so that a first ratio, of the first scan-driven touch lines to the first touch lines RX formed in the first area AR1, and a second ratio, of the second scan-driven touch lines to the first touch lines RX formed in the second area AR2, are different from each other. For example, if it is assumed that each of the first area AR1 and the second area AR2 includes five first touch lines RX, The touch-IC 200 can control the first ratio to be 0% by not scan-driving all of the five first touch lines formed in the first area AR1. At this point, the touch-IC 200 can control the second ratio to be 60% by scan-driving three of the five first touch lines formed in the second area AR2.

Since the first and second areas AR1 and AR2 illustrated in FIG. 3 are adjacent to each other in the second direction DR2 to share each of the second touch lines TX, the scan-driven ratio of the second touch lines TX formed in the first area AR1 and the scan-driven ratio of the second touch lines TX formed in the second area AR2 can be identical. However, unlike FIG. 3, in a case where the first and second areas AR1 and AR2 are not adjacent to each other in the second direction DR2 and do not share each of the touch lines TX, the touch-IC 200 can control the scan-driven ratio of the second touch lines TX formed in the first area AR1 and the scan-driven ratio of the second touch lines TX formed in the second area AR2 to be different.

In some embodiments, a case where different widgets are executed in the first and second areas AR1 and AR2 is exemplarily described, but it is not limited hereto. The touch screen panel 100 can execute different widgets or applications in three or more areas, and the touch-IC 200 can individually control the touch driving characteristics in three or more areas according to the touch using policies of the widgets or applications respectively executed in three or more areas.

In some embodiments, since the touch screen panel 100 is flexible, the touch screen panel 100 can be curved with a gap between the first and second areas AR1 and AR2 taken as a boundary.

For an image display terminal according to an embodiment, the touch driving characteristic of an area in which a widget or an application is displayed can be individually controlled according to the touch using policy of the widget or the application. Accordingly, the touch sensitivity or the touch reaction speed can be improved by concentrating touch sensing performance in a specific area on the touch screen panel 100. In addition, power consumption can be improved by minimizing an unnecessary touch driven area in the touch screen panel 100.

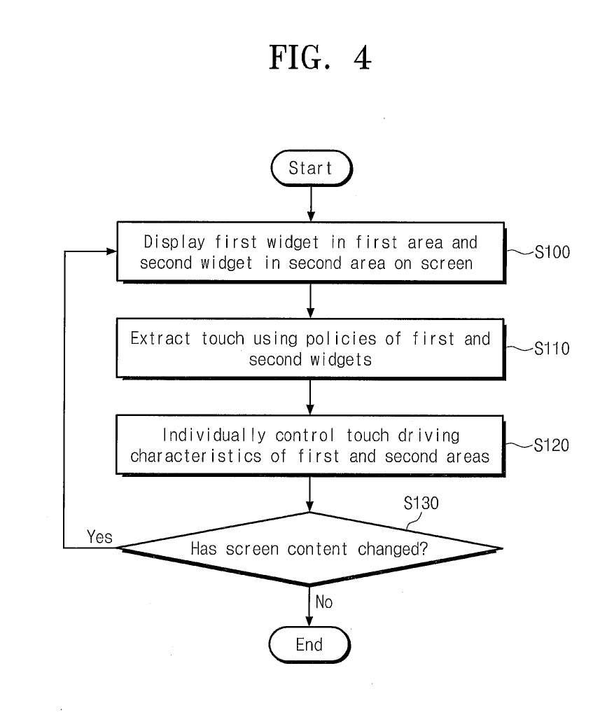

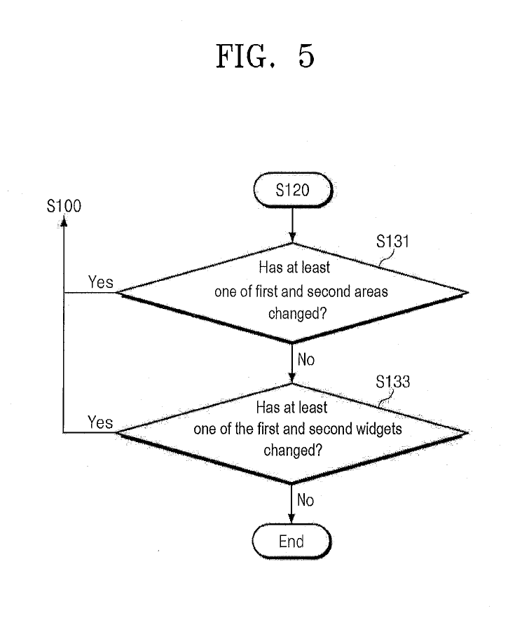

FIG. 4 is a flowchart illustrating a touch control method of an image display terminal according to an embodiment. FIG. 5 is a flowchart illustrating operation S130 of FIG. 4.

In some embodiments, the FIG. 4 procedure is implemented in a conventional programming language, such as C or C++ or another suitable programming language. The program can be stored on a computer accessible storage medium of the image display terminal 1000, for example, a memory (not shown) of the image display terminal 1000 or the application processor 300. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 8/7/Vista/2000/9x/ME/XP, Macintosh OS, OS X, OS/2, Android, iOS and the like. In another embodiment, at least part of the procedure can be implemented with embedded software. Depending on the embodiment, additional states can be added, others removed, or the order of the states changed in FIG. 4. The description of this paragraph applies to the embodiments shown in FIG. 5.

Referring to FIGS. 1, 3 and 4, the first widget is displayed in the first area AR1 and the second widget is displayed in the second area AR2 on the screen (operation S100). The first and second areas AR1 and AR2 can be different parts of areas on one screen displayed on the touch screen panel 100.

The window manager 510 can manage touch using policies of the first and second widgets. The touch manager 520 extracts the touch using policies of the first and the second widgets (operation S110). The touch manager 520 can provide the extracted touch using policies of the first and second widgets to the touch-IC 200 through the OS 400 and the AP 300.

The touch-IC 200 can individually control touch driving characteristics of the first area AR1 and the second area AR2 based on the touch using policies of the first and second widgets (operation S120), Since detailed description is provided with reference to FIGS. 1 to 3, it will be omitted.

Then, it is determined whether content on the screen has changed (operation S130). Operation S130 can include determining whether at least any one of the first and second areas AR1 and AR2 has changed (operation S131) and determining whether at least any one of the first and second widgets has changed (operation S133).

In operation S131, it is determined whether a position or a size of at least any one of the first and second areas AR1 and AR2 has changed. In operation S133, it is determined whether any one of the first and second widgets is terminated or converted into another task, or whether the touch using policy of any one of the first and second widgets has changed.

In operation S130, it is determined that screen content has changed when any one of the first and second area AR1 and AR2 has changed or any one of the first and second widgets has changed. In operation S130, when the screen content is determined to have changed, the method proceeds to operation S100. In operation S130, when the screen content is determined to not have changed, the touch driving characteristics in the first and second areas AR1 and AR2 are maintained.

According to at least one of the disclosed embodiments, touch sensitivity or a touch reaction speed of a touch screen panel can be increased and power consumption can be improved.

The above-disclosed subject matter is to be considered illustrative and not restrictive, and the appended claims are intended to cover all such modifications, enhancements, and other embodiments, which fall within the true spirit and scope of the inventive technology. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A method of controlling a touch for an image display terminal, the method comprising:
displaying a first widget in a first area on a touch screen and a second widget in a second area on the touch screen different from the first area;
extracting a first touch policy of the first widget and a second touch policy of the second widget; and
individually controlling touch driving characteristics of the first and second areas based on the first and second touch policies.

2. The method of claim 1, wherein the individually controlling of the touch driving characteristics comprises controlling the first and second areas to have different touch sensitivities.

3. The method of claim 1, wherein the individually controlling of the touch driving characteristics comprises controlling the first and second areas to have different touch reaction speeds.

4. The method of claim 1, wherein the first area includes a plurality of first touch lines formed in a first direction, wherein the second area includes a plurality of second touch lines formed in the first direction, and wherein the individually controlling of the touch driving characteristics comprises controlling a first ratio of scan-driven touch lines to the first touch lines and a second ratio of scan-driven touch lines to the second touch lines to be different.

5. The method of claim 1, wherein the individually controlling of the touch driving characteristics comprises activating touch sensitivity of the first area and deactivating touch sensitivity of the second area.

6. The method of claim 1, further comprising:
determining whether content of the screen has changed; and
displaying the first widget in the first area and the second widget in the second area when the content of the screen has changed.

7. The method of claim 6, wherein the determining of whether the content of the screen has changed comprises:
determining whether at least any one of the first and second areas has changed; and
determining whether at least any one of the first and second widgets has changed.

8. The method of claim 7, wherein the determining of whether the content of the screen has changed further comprises determining that the content of the screen has changed when at least one of the first and second areas has changed or at least one of the first and second widgets has changed.

9. An image display terminal, comprising:
a touch screen panel configured to i) display a first widget in a first area and a second widget in a second area different from the first area and ii) sense an input touch event;
a touch driver configured to control a touch sensing of the touch screen panel and create a coordinate of the touch event;
a window manager configured to manage a first touch policy of the first widget and a second touch policy of the second widget; and
a touch manager configured to extract the first and second touch policies from the window manager to provide the extracted first and second touch policies to the touch driver,
wherein the touch driver is further configured to individually control touch driving characteristics of the first and second areas based on the first and second touch policies.

10. The image display terminal of claim 9, wherein the touch driver is further configured to control the first and second areas to have different touch sensitivities.

11. The image display terminal of claim 9, wherein the touch driver is further configured to control the first and second areas to have different touch speeds.

12. The image display terminal of claim 9, wherein the touch screen panel comprises a plurality of touch lines formed in a first direction, wherein the touch lines include first and second touch lines formed in the first and second areas, wherein the first and second touch lines each include one or more scan-driven touch lines and wherein the touch driver is further configured to control a first ratio of the one or more scan-driven touch lines to the first touch lines and a second ratio of one or more scan-driven touch lines to the touch lines are different.

13. The image display terminal of claim 9, wherein the touch driver is further configured to activate touch sensitivity of the first area and deactivate touch sensitivity of the second area.

14. The image display terminal of claim 9, wherein the touch screen panel comprises:
a display configured to display an image including the first and second widgets; and
a touch sensor configured to sense the input touch event.

15. An image display terminal, comprising:
a touch screen panel configured to i) display a first widget in a first area and a second widget in a second area different from the first area and ii) sense an input touch event, wherein the first and second widgets respectively have first and second touch policies;
a touch driver configured to control a touch sensing of the touch screen panel and create a coordinate of the touch event; and
a touch manager configured to provide the first and second touch policies to the touch driver,
wherein the touch driver is further configured to individually control touch driving characteristics of the first and second areas based on the first and second touch policies.

16. The image display terminal of claim 15, further comprising an application processor configured to control the touch screen panel and the touch driver.

17. The image display terminal of claim 15, wherein the touch driver is further configured to control the first and second areas to have different touch sensitivities.

18. The image display terminal of claim 15, wherein the touch driver is further configured to control the first and second areas to have different touch speeds.

19. The image display terminal of claim 15, wherein the touch screen panel comprises a plurality of touch lines formed in a first direction, wherein the touch lines include first and second touch lines formed in the first and second areas, wherein the first and second touch lines each include one or more scan-driven touch lines, and wherein the touch driver is further configured to control a first ratio of the one or more scan-driven touch lines to the first touch lines and a second ratio of one or more scan-driven touch lines to the touch lines are different.

20. The image display terminal of claim 15, wherein the touch driver is further configured to activate touch sensitivity of the first area and deactivate touch sensitivity of the second area.
